(19) United States
(12) Patent Application Publication
(10) Pub. No.: US 2025/0167236 A1
(43) Pub. Date: May 22, 2025

(54) LITHIATED CARBOXYLATED NITRILE BUTADIENE RUBBER AND USE THEREOF AS BINDER IN SULFUR CATHODES

(71) Applicant: AIRBOSS OF AMERICA CORP., Newmarket (CA)

(72) Inventors: Yuning LI, Newmarket, ON (CA); Zhong MA, Newmarket, ON (CA); Ali VAHIDIFAR, Newmarket, ON (CA); Abbas GHANBARI, Newmarket, ON (CA); Steven YU, Newmarket, ON (CA)

(73) Assignee: AIRBOSS OF AMERICA CORP., Newmarket, ON (CA)

(21) Appl. No.: 18/841,419

(22) PCT Filed: Feb. 27, 2023
(86) PCT No.: PCT/IB2023/051811

§ 371 Date: Aug. 26, 2024

Related U.S. Application Data
(60) Provisional application No. 63/268,491, filed on Feb. 25, 2022.

(51) Int. Cl. H01M 4/62; C08C 19/26; H01M 4/02; H01M 4/13; H01M 4/38; H01M 10/052

(52) U.S. Cl. CPC H01M 4/622; C08C 19/26; H01M 4/13; H01M 4/38; H01M 4/625; H01M 10/052; H01M 2004/028

(57) ABSTRACT

Synthesis of lithiated carboxylated nitrile butadiene rubber (XNBR-Li) and its use as a functional binder for the sulfur cathode of lithium sulfur batteries (LSBs) are disclosed. Compared to carboxylated nitrile butadiene rubber (XNBR), XNBR-Li has stronger adhesion to sulfur and carbon black particles, forming a more uniformly dispersed and robust sulfur cathode structure. Furthermore, due to the presence of the —COOLi groups, XNBR-Li has shown a greatly improved ability to trap lithium polysulfides (LPS), which helps to suppress the shuttle effect of LPS in LSBs. In addition, the cyclic voltammetry and electrochemical impedance spectroscopy data indicate that the use of XNBR-Li as the binder can accelerate lithium-ion diffusion kinetics in the sulfur cathode.

This application claims the priority benefit of U.S. Provisional Application Ser. No. 63/268,491, filed Feb. 25, 2022, the contents of which are incorporated by reference herein.

### BACKGROUND

The growing demand for high energy storage capacity rechargeable batteries used in transportation and grid storage has stimulated extensive exploration of new electrode materials with inherently high specific capacities. As one of the most promising cathode materials to meet this need, sulfur(S) has a theoretical specific capacity of 1672 mAh/g, which corresponds to a high specific energy of 2600 Wh/kg when used in lithium-sulfur batteries (LSBs) and has therefore attracted a lot of attention. In addition, elemental sulfur is naturally occurring, abundant, inexpensive, less toxic, and environmentally benign. However, the notorious “shuttle effect” of the soluble intermediate long-chain lithium polysulfides (LPS, Li₂Sₙ, 4≤n≤8) results in the continuous loss of active sulfur and an increased surface impedance of the anode, leading to a rapid drop in battery performance. Furthermore, during battery cycling, the drastic volume change (up to 80%) between elemental sulfur in the charged state and lithium sulfide (Li₂S) in the discharged state can pulverize the sulfur cathode and shorten the battery life.

High affinity sulfur hosts, LPS conversion electrocatalysts, and porous structures have been used to overcome the dissolution of LPS, while the encapsulation of sulfur in a host with excess space and the construction of a cross-linked network have been adopted to buffer the volume change of sulfur cathode. In sulfur cathodes, the binder accounts for only a small portion (e.g., about 10%), but it plays a vital role in determining battery performance. The binder ensures close contact between the sulfur particles and conductive additives such as carbon black, provides strong adhesion to the active material on the current collector, and maintains the integrity of the electrode structure. Some multi-functional binders also contain heteroatoms (such as oxygen and nitrogen) for trapping LPS, transition metals (such as Zn) for trapping LPS and catalyzing the redox reaction of S species, and conductive polymers for improving the conductivity of the sulfur cathode.

Rubbers (elastomers), such as natural rubber (NR), styrene butadiene rubber (SBR), nitrile butadiene rubber (NBR), and carboxylated nitrile butadiene rubber (XNBR), have high elasticity and can return to their original state even after being stretched to 500%, making them promising binder candidates for active electrode materials with large volume changes during charging and discharging, such as silicon (Si) and S. In particular, XNBR has highly polar cyano (—CN) and carboxylic acid (—COOH) groups, which have good LPS trapping capabilities.

### BRIEF DESCRIPTION

To further improve the overall performance of XNBR as a sulfur cathode binder, the polymer may be lithiated by simply reacting lithium hydroxide (LiOH) with its carboxylic acid group (—COOH) to form the lithiated XNBR (XNBR-Li). The sulfur cathode with XNBR-Li as the binder shows much better performance compared to that using XNBR or PVDF as the binder.

Disclosed, in some embodiments, is a lithiated carboxylated nitrile butadiene rubber of the formula:

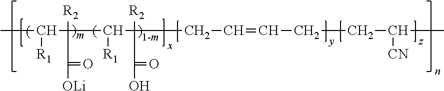

wherein R₁ is selected from the group consisting of hydrogen (H), a hydrocarbon group (e.g., methyl, 1-propenyl, etc.), and a carboxylic acid group (—COOH); R₂ is selected from the group consisting of hydrogen and a hydrocarbon group (e.g., methyl, ethyl, etc.); x is in the range of about 0.05 to about 0.5; y is in the range of about 0.05 to about 0.75; z is in the range of about 0.05 to about 0.75; x+y+z=1; m is in the range of 0.1 to 1; and n is the number of repeat units and is in the range of from about 100 to about 1,000,000.

The lithiated carboxylated nitrile butadiene rubber may have the formula:

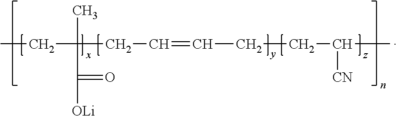

Disclosed, in other embodiments, is a sulfur cathode including: a sulfur-containing material; a conductive material; and the lithiated carboxylated nitrile butadiene rubber binder.

The binder may be included in an amount of from about 1 wt % to about 50 wt %, including from about 2 wt % to about 30 wt % and from about 5 wt % to about 20 wt %.

In some embodiments, the sulfur-containing material is elemental sulfur.

The conductive material may be selected from one or more of carbon black, carbon nanotubes, carbon nanofibers, graphene, and graphite.

Disclosed, in further embodiments, is a battery including: a lithium anode and a sulfur cathode; wherein the sulfur cathode contains: a sulfur-containing material; a conductive material; and a lithiated carboxylated nitrile butadiene rubber binder.

A method for synthesizing a lithiated carboxylated nitrile butadiene rubber is also disclosed. The method includes reacting a carboxylated nitrile butadiene rubber with lithium hydroxide.

The carboxylated nitrile butadiene rubber may have a carboxylic acid group content of from about 5 wt % to about 50 wt % and an acrylonitrile group content of from about 5 wt % to about 75 wt %.

In some embodiments, the carboxylated nitrile butadiene rubber has a carboxylic acid group content of about 7 wt % and an acrylonitrile group content of about 27 wt %.

The lithium hydroxide may be present at a molar ratio of from 0.1 to 1 to the amount of carboxylic acid groups of the carboxylated nitrile butadiene rubber.

In some embodiments, the lithium hydroxide is present at a molar ratio of 1:1 to the amount of carboxylic acid groups of the carboxylated nitrile butadiene rubber.

The reaction may occur in a solvent selected from N-methyl-2-pyrrolidinone, N,N-dimethylformamide, N,N-dimethylacetamide, tetrahydrofuran, butyl acetate, ethyl butyl acetate, ethyl hexyl acetate, methyl glycol acetate, methyl ethyl ketone (MEK), methyl isobutyl ketone (MIBK), toluene, chlorobenzene, o-dichlorobenzene, and trichlorobenzene, or a mixture of any two or more thereof.

In some embodiments, the reaction occurs at a temperature of from about 0° C. to about 100° C. (e.g., 70° C.) for a period of from about 0.1 hour to about 24 hours (e.g., about 2 hours).

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a cross-sectional view of a lithium sulfur rechargeable battery in accordance with some embodiments of the present disclosure.

FIG. 2 is a graph illustrating the galvanostatic potential profiles of Li—S cells with 1.0 M LiTFSI DOL/DME (5/5) with 2 wt % LiNO₃ electrolyte at a 0.2 C rate, according to the examples.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure relates to a lithiated carboxylated nitrile butadiene rubber (XNBR-Li). The lithiated carboxylated nitrile butadiene rubber may be of the formula:

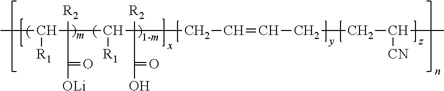

wherein R₁ is hydrogen (H), a hydrocarbon such as methyl and 1-propenyl, a carboxylic acid group (—COOH), etc., R₂ is hydrogen (H), a hydrocarbon such as methyl or ethyl, etc., x is in the range of about 0.05-0.5, y is in the range of about 0.05-0.75, z is in the range of about 0.05-0.75, x+y+z=1, m=0.1-1, and n is the number of repeat unit in the range of from about 100 to about 1,000,000.

In some embodiments, R₁ is hydrogen, R₂ is methyl, and m=1 and the lithiated carboxylated nitrile butadiene rubber is of the formula:

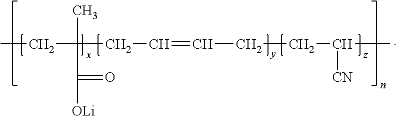

where x, y, z, and n are defined as above.

The lithiated carboxylated nitrile butadiene rubber may be formed by reacting a carboxylated nitrile butadiene rubber (XNBR) with lithium hydroxide, where the carboxylated nitrile butadiene rubber is a copolymer of acrylonitrile, butadiencee, and an unsaturated carboxylic acid such as acrylic acid, methacrylic acid, crotonic acid, itaconic acid, fumaric acid, or sorbic acid with a general formula:

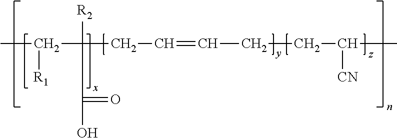

where R₁, R₂, x, y, z, and n are defined as above.

In some embodiments, R₁ is hydrogen, R₂ is methyl, and m=1 and the carboxylated nitrile butadiene rubber is of the formula:

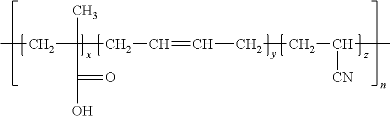

where x, y, z, and n are defined as above.

The reaction may occur by adding lithium hydroxide (LiOH) to a solution of carboxylated nitrile butadiene rubber at a LiOH/—COOH molar ratio of about 0.1 to about 1 in a solvent such as N-methyl-2-pyrrolidinone, N,N-dimethylformamide, N,N-dimethylacetamide, tetrahydrofuran, butyl acetate, ethyl butyl acetate, ethyl hexyl acetate, methyl glycol acetate, methyl ethyl ketone (MEK), methyl isobutyl ketone (MIBK), toluene, chlorobenzene, o-dichlorobenzene, trichlorobenzene, at a temperature of from about 0° C. to about 100° C. for a period of from about 0.1 hour to about 24 hours.

The reaction may be facilitated by stirring the solution until the lithium hydroxide disappears. For example, the stirring may occur for about 2 hours and/or at a temperature of about 70° C.

The lithiated carboxylated nitrile butadiene rubber may be used as a binder material for a sulfur cathode. The sulfur cathode may contain a sulfur-containing material; a conductive material; and the lithiated carboxylated nitrile butadiene rubber binder.

The binder may be present in an amount of from about 1 wt % to about 50 wt %, including from about 5 wt % to about 45 wt % and about 10 wt % to about 30 wt %.

The sulfur-containing material may include elemental sulfur as well as molecules and macromolecules that contain at least one sulfur atom, such as ammonium sulfate and ammonium sulfide, lithium sulfide, molten sulfur, liquids containing sulfur. Exemplary materials include organosulfur compounds, elemental sulfurs, sulfates, sulfites, sulfides, disulfides, thio compounds (thioethers, thioketones), thiols, thiolates, mercaptans, sulfones, sulfoxides, lithium sulfide, etc. In some embodiments, the sulfur source contains a negatively charged or proton-associated sulfur atom that is covalently bound to another atom through a single bond. This type of sulfur source is capable of releasing an associated cation or proton and forming a disulfide bond with a similar atom. In other embodiments, the sulfur source may contain sulfur atoms that are multiply bound to other atoms and are not capable of forming disulfide bonds. In all aspects, the sulfur source refers to atoms, molecules, and macromolecules that contain at least one sulfur atom that can act as a redox species, in part or in whole. As used herein, the term redox species includes atoms, molecules, or macromolecules that accepts or releases one or more electrons when placed under an electric field of appropriate direction and magnitude.

The sulfur-containing material may be in particulate form, having a particle size from about 1 nm to about 100 μm, including from about 1 nm to about 1 μm and from about 1 nm to about 500 nm. The sulfur-containing material may also be molecularly dispersed in a matrix such as a polymer phase or bound to a matrix such as a polymer.

The conductive material may be selected from carbon black, carbon nanotubes, graphite, graphene, carbon nanofibers, metal particles (e.g., nanoparticles and nanowires), conductive particles, and conductive polymers.

An additional LPS trapping agent such as a metal oxide (TiO₂, ZnO, etc.) and/or an organometallic compound (such as Zn(COOCH₃)₂-diethanoamine) can be added to the sulfur electrode. The amount of this LPS trapping agent may be in the range of from about 1% to about 30% and from about 5% to about 20% of the total sulfur cathode composition.

A catalyst such as a metal oxide (TiO₂, MnO₂, etc.), a metal nitride (TIN, Ni₃N, etc.), a metal carbide (Fe₃C, NbC, etc.), or an organometallic compound (such as Zn(COOCH₃)₂-diethanoamine) can be added to the sulfur electrode to facilitate the sulfur redox reactions. The amount of this redox catalyst may be in the range of from about 1% to about 30% and from about 5% to about 20% of the total mass of the sulfur cathode composite.

An additional binder such as PVDF, LA133 (a water dispersion of acrylonitrile multi-copolymer), and Zn(COOCH₃)₂-diethanoamine can be added to the sulfur cathode composite. The amount of this additional binder may be in the range of from about 1% to about 30% and from about 5% to about 20% of the total mass of the sulfur cathode composite.

Additives, such as antioxidants may be added too.

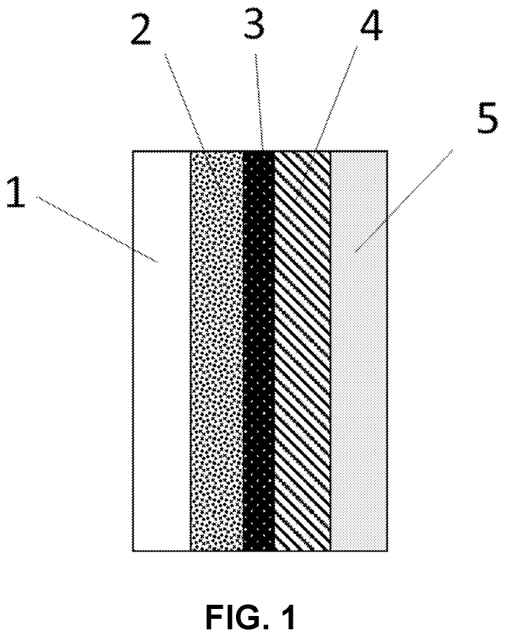

The battery of the present disclosure, in addition to the sulfur cathode, may include a lithium-containing anode and an electrolyte between the anode and the cathode. A separator may also be provided between the anode and the cathode. The separator may be a porous substrate that is permeable to lithium ions. The battery may further include a first current collector associated with the anode and/or a second current collector associated with the cathode. FIG. 1 is a schematic drawing of a lithium sulfur rechargeable battery including a cathode current collector 1; a sulfur cathode layer 2 containing the lithiated XNBR (XNBR-Li); a bulk electrolyte layer 3, which optionally comprises a separator; 4 a lithium anode; and an anode current collector 5.

The following examples are provided to illustrate the devices and methods of the present disclosure. The examples are merely illustrative and are not intended to limit the disclosure to the materials, conditions, or process parameters set forth therein.

### Examples

A commercial XNBR (Nipol NX 775, Zeon Chemicals) with 27 wt. % acrylonitrile and 7 wt. % carboxylic acid content was used in this work. XNBR-Li was prepared by adding the stoichiometric molar ratio of lithium hydroxide (n_{LiOH}/n_{-COOH}=1) into an XNBR solution in N-methyl-2-pyrrolidinone (NMP) under stirring at 70° C. for 2 h. The obtained XNBR-Li NMP solution was stored for further use without purification. The sulfur/carbon composite was prepared by heating a well-ground mixture of sulfur and Super P (Timcal) with a mass ratio of 6:4 at 155° C. for 12 h. The sulfur electrode was fabricated by coating a slurry containing the sulfur/carbon composite as the active material and XNBR-Li as the binder with a mass ratio of 9:1 using NMP as a solvent on a carbon-coated aluminum current collector. For comparison, sulfur electrodes using XNBR and polyvinylidene fluoride (PVDF) as the binder were also prepared using a similar procedure.

All electrochemical studies were carried out on CR2032 coin cells assembled in an argon-filled glovebox with both O₂ and H₂O concentrations below 0.5 ppm. A lithium metal foil was used as the anode, 1 M lithium bis-(trifluoromethanesulfonyl)imide (LiTFSI) in 1,2-dimethoxyethane (DME) and 1,3-dioxolane (DOL) mixed solvent (v/v=1:1) containing 2 wt. % LiNO₃ was used as the electrolyte, and a Celgard 2400 film was used as the separator. Cyclic voltammetry (CV) measurement was carried out with a Bio-logic electrochemical potentiostat/galvanostat (VSP) in the potential range of 1.7-2.8 V (vs. Li/Li⁺) at different scan rates (0.1-0.5 mV/s). The galvanostatic charge-discharge tests were conducted in a voltage window of 1.7-2.8 V (vs. Li/Li⁺) on a Land CT2001A battery test system at different rates (0.1-2 C). Electrochemical impedance spectroscopy (EIS) curves were recorded using the VSP in a frequency range from 1000 kHz to 0.1 Hz with an AC voltage amplitude of 10 mV at the open-circuit potential (OCP).

The Li₂S₆ solution was prepared by heating a mixture of Li₂S and S with a molar ratio of 1:5 in DME at 80° C. for 12 h with stirring. The Li₂S₆ solution was diluted to 0.5 M for further use. For the LPS adsorption experiment, 20 mg of binder (XNBR-Li or XNBR) was added into 4 mL of 2 mM Li₂S₆ solution with stirring for 4 h. The supernatant was collected for UV-Vis absorption measurement using a Cary 7000 Universal Measurement Spectrophotometer (UMS). The morphologies of the sulfur electrodes before and after cycling were characterized by a scanning electron microscope (SEM, FEI Quanta FEG 250).

The density functional theory (DFT) calculations were performed using Cambridge serial total energy package (CASTEP) code. The optimization of geometric structures was conducted using PW91 functional within the generalized gradient corrected (GGA) approximation. Geometric convergence tolerances were used with the maximum force of 0.05 eV/Å, maximum energy change of 2×10⁻⁵ eV/atom, maximum displacement of 0.002 Å, and maximum stress of 0.1 GPa. The cutoff energy was set to 350.0 eV. The binding energy (E_{b}) of Li₂S₆ adsorption on rubber is expressed as E_{b}=E_{R-Li2S6}−E_{R-ELi2S6}, Where E_{R-Li2S6}, E_{R} and E_{Li2S6} are the total energy of Li₂S₆ adsorption on rubber, the energy of rubber, and the energy of Li₂S₆, respectively.

The lithiation of a commercial XNBR was carried out by reacting XNBR with LiOH to form XNBR-Li as shown below

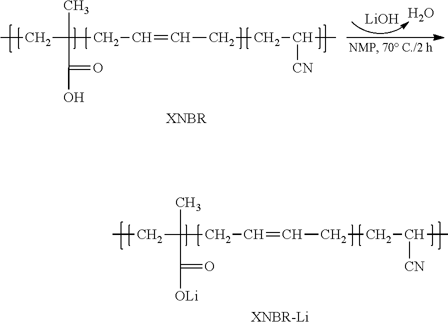

where XNBR contains 27 wt. % of acrylonitrile (—CN) and 7 wt. % of carboxylic acid. Specifically, a stoichiometric amount of LiOH was added to the NMP solution of XNBR (40 mg/mL) at a LiOH/—COOH molar ratio of 1:1, and the mixture was stirred at 70° C. for 2 h until all solid LiOH disappeared. Since water is the only by-product of the reaction, and NMP is the solvent for preparing the sulfur cathode slurry in the next step, the resulting transparent solution was cooled to room temperature and stored for further use without purification. Since the —COOH groups in XNBR were converted to —COOLi groups in XNBR-Li, it was first verified whether the LPS trapping ability of XNBR-Li is affected. The LPS adsorption test was performed by adding 20 mg of XNBR or XNBR-Li into 4 mL of 2 mM Li₂S₆ in 1,2-dimethoxyethane (DME) solution, and then stirring the mixture in a sealed vial at room temperature for 4 h. The color changed from yellow for the original 2 mM Li₂S₆ solution to nearly colorless for the solution with XNBR-Li. The solution with XNBR has become significantly lighter, but still yellowish. A rough visual evaluation shows that XNBR-Li's LPS capture capability is significantly improved. In order to quantitatively determine the LPS trapping ability, the supernatant of the mixture was further analyzed by ultraviolet-visible (UV-vis) spectroscopy. The concentrations of Li₂S₆ before and after the LPS adsorption test were calculated by the Beer-Lambert law: A=ε [symbol] c, where A is the absorbance, ε is the molar attenuation coefficient of the attenuating species, [symbol] is the optical path length in cm, and c is the concentration of the solution. The absorbance at 475 nm associated to Li₂S₆ decreased more significantly for the XBNR-Li-based solution compared to the XNBR-based solution, indicating the much stronger LPS trapping ability of XNBR-Li. The trapping ability of XNBR-Li (0.29 mmol_{Li2S6}/g_{rubber}) is 1.5 times higher than that of XNBR (0.19 mmol_{Li2S6}/g_{rubber}). Since the only change from XNBR to XNBR-Li is the conversion of —COOH groups to —COOLi groups, the presence of —COOLi groups is most likely responsible for the increased LPS trapping capacity of XNBR-Li.

In order to understand the LPS trapping effect of —COOLi groups in XNBR-Li, DFT simulations were performed. Since the polar —COOLi and —CN groups in XNBR-Li are most responsible for trapping LPS, their binding energy with Li₂S₆ was calculated. The conformations of adsorbed Li₂S₆ on different functional groups in the model compounds (seximers) of XNBR-Li and XNBR and the binding energy values were evaluated. For comparison, the binding energy of fluorine atoms of a PVDF model compound (a seximer) with Li₂S₆ was also simulated. For clarity, the first and second O atoms in the —COOH or —COOLi group are assigned to that in C═O and that in —OH or —OLi, respectively, while the atom that involving the interaction between Li₂S₆ and —COOH or —COOLi is shown in bold. A binding energy of 0.59 eV between two-F atoms in PVDF and two Lit ions in Li₂S₆ was obtained, which is comparable to the values reported previously. For XNBR, the binding energy between-CN and Li₂S₆ (—CN . . . LiS₆Li) is 0.85 eV, which is much stronger than that between-F in PVDF and Li₂S₆ and agrees with previous reports. There are two possible adsorption conformations of Li₂S₆ on —COOH: One is between the O atom of —C═O of —COOH and one Li atom of Li₂S₆ (or —COOH . . . LiS₆Li), and the other is between two O atoms of —COOH and two Li atoms of Li₂S₆ (or —COOH . . . LiS₆Li). Their binding energies are 0.87 eV and 0.78 eV, respectively, indicating that the interaction-COOH . . . LiS₆Li is more preferred. Compared with the —CN group, the —COOH group of XNBR has a slightly higher affinity for LPS, which is consistent with the previous study. For XNBR-Li, the binding energy between —CN and Li₂S₆ increased to 0.94 eV, due to the presence of a neighboring —COOLi group. For the —COOLi group, the O atom of —C═O interacts with one Li atom in Li₂S₆ (—COOLi . . . LiS₆Li), which is similar to the interaction of —COOH . . . LiS₆Li for XNBR. However, at the same time, the Li atom of —COOLi interacts with the terminal S atom on the other side of Li₂S₆ (or —COOLi . . . LiSS₄SLi). This double interaction —COOLi:::LiSS₄SLi results in a very high binding energy of 2.53 eV, which is the highest among the binding energy values of all the interactions between Li₂S₆ and PVDF, XNBR, or XNBR-Li. This value is also much larger than any type of interaction between LPSs and other common organic polymer binders (such as PVP, PEDOT, and polyaniline), and is comparable to the binding energy between LPS and some metal sulfides.

In order to understand the strengthened interaction between Li₂S₆ and —COOLi in XNBR-Li, the partial density of states (PDOS) of O atoms for the —COOH group in XNBR and the —COOLi group in XNBR-Li without Li₂S₆ adsorption were simulated. The energy density of the O 2p orbitals for —C=O and —OLi are much closer to the Femi energy level (0 eV) in XNBR-Li compared to that for —C=O and —OH in XNBR, respectively, which indicates that the O atoms in —COOLi are more active. When interacting with Li₂S₆, the PDOS of the O atoms of —COOLi (in XNBR-Li) and —COOH (in XNBR) and of a Li in Li₂S₆ were calculated. For both XNBR-Li and XNBR, the Li 2s orbital does not overlap with the O 2s orbital but overlaps with the O 2p orbital in the high energy range between −3 eV and −1 eV. However, the overlapping area for Li 2s and O 2p orbitals is much greater in XNBR-Li than in XNBR, indicating that the Li 2s orbital is much more hybridized with O 2p in the former. This may be the reason for the much stronger interaction between LPS and the —COOLi group in XNBR-Li. Since the interaction of —COOH . . . LiS₆Li also exists in XNBR, the PDOS of two Li atoms of Li₂S₆ and two O atoms of —COOH in XNBR were also simulated. There is almost no hybridization between the Li 2s and O 2s or O 2p orbitals in the high energy region of −3 eV to 0 eV.

A slurry containing 90% sulfur/carbon composite (S:Super P=6:4) and 10% XNBR-Li as the binder was prepared and used to coat sulfur cathodes on a carbon coated Al foil. For comparison, sulfur cathodes using XNBR or PVDF as the binder were also prepared. The SEM images show that the XNBR-Li-based sulfur electrode has much smaller, well-dispersed particles compared to the XNBR-based sulfur cathode, suggesting that XNBR-Li has superior adhesion to the sulfur and carbon particles. Coin batteries were assembled using the XBNR-Li or XNBR based sulfur cathode, lithium metal as the anode, 1 M LiTFSI in DME/DOL (v/v=1:1) containing 2 wt. % LiNO₃ as the electrolyte. The specific capacities of the sulfur cathodes were evaluated by galvanostatic discharge-charge test in potential range of 1.7-2.8 V (vs. Li/Li⁺) at the rate of 0.2 C. A specific capacity of 1140 mAh/g was delivered by the XNBR-Li-based sulfur cathode, which is 12% higher than that of XNBR-based sulfur cathode (1020 mAh/g). Furthermore, the XNBR-Li-based sulfur cathode showed a capacity of 375 mAh/g for the first plateau with 90% sulfur utilization, which is also much higher than that (a capacity of 335 mAh/g with 80% sulfur utilization) obtained for the XNBR-based sulfur cathode, indicating the better ionic and charge diffusion kinetics in the former. The sulfur cathode with PVDF as the binder only showed a capacity of 990 mAh/g at the same rate, which is much lower than the sulfur cathodes with XNBR-Li and XNBR. The higher capacities for the XNBR and XNBR-Li-based sulfur cathodes may be attributed to the high affinity of the polar groups in XNBR-Li and XNBR, namely —CN, —COOLi, and —COOH. The CV measurement was carried out on the XNBR-Li-based cathode at a scan rate of 0.1 mV/s to evaluate its electrochemical performance. The CV curve of this cathode shows the typical two pairs of cathodic/anodic peaks, which corresponds to the two-step reversible redox reaction between S and Li₂S. The XNBR-based cathode also showed two pairs of redox peaks, but both reduction and oxidation peaks are delayed. The results indicate that the redox kinetics of sulfur species in the XNBR-Li-based cathode is enhanced. The XNBR-Li-based cathode also showed a much better rate capability than the XNBR-based cathode. Even at a high rate of 2 C, the XNBR-Li-based cathode still delivered a capacity of 729 mAh/g or 65% of the capacity at 0.1 C. On the other hand, the capacity of the XNBR-based cathode is only 491 mAh/g at 2 C or 50% of the capacity at 0.1 C. The XNBR-Li-based cathode also showed a good cycling stability with a capacity retention of 75% after 100 cycles at 0.2 C, while for the XNBR-based cathode a capacity retention of only 66% was obtained. The long-term cycling stability of the XNBR-Li-based cathode was further investigated at 0.5 C. A capacity of 750 mAh/g remained after 500 cycles, which corresponds to a low-capacity decay rate of 0.04% per cycle.

Electrochemical impedance spectroscopy (EIS) was used to investigate the resistances of the cells. The two sulfur cathodes (XNBR-Li and XNBR) showed similar series resistances (Rₛ) because the same electrolyte was used. However, the charge transfer resistance (R_{ct}) of the XNBR-Li-based sulfur cathode is only 56.9Ω, which is significantly lower than that (233.3Ω) of the XNBR-based sulfur cathode, indicating that the Lit conductivity in the XNBR-Li-based sulfur cathode is much higher. The diffusion coefficients of Li⁺ in the batteries were further determined by CV measurements with different scan rates. The diffusion coefficient of the Lit can be calculated according to the Randles-Sevcik equation:

$${I}_{p} = 2.69 \times {10}^{5} {n}^{3 / 2} {SD}_{{Li}^{+}}^{1 / 2} {C}_{{Li}^{+}} {v}^{1 / 2} \qquad ( 1 )$$

where Iₚ is the peak current (A), n is the electron charge number (n=2 for LSBs), S is the area of the electrode (S is 1.13 cm² here), D_{Li}⁺ is the lithium ion diffusion coefficient (cm²/s), C_{Li}⁺ is the Li-ion concentration change during reaction (C_{Li}⁺ is 0.001 mol cm⁻³), and u is the scan rate (V/s). Because n, S, and C_{Li}⁺ are given data, there is a linear relationship between Iₚ and u^{1/2}, and D_{Li}⁺ is correlated positively to the slopes of the curves (Iₚ/u^{1/2}). For the sulfur cathode with XNBR as the binder, the Li⁺ diffusion coefficients are 2.0×10⁻⁸ cm²/s/8.8×10⁻⁸ cm²/s and 7.3×10⁻⁸ cm²/s/2.1×10⁻⁷ cm²/s for the two cathodic peaks and anodic peaks, respectively. For the cathode with XNBR-Li, the Lit diffusion coefficients increased to 4.3×10⁻⁸ cm²/s/1.5×10⁻⁷ cm²/s and 1.9×10⁻⁷ cm²/s/4.7×10⁻⁷ cm²/s, respectively. The D_{Li}⁺ data indicate that Li⁺ diffusion in the cell was indeed enhanced when XNBR-Li was as the binder. The improved Li⁺ diffusion may be due to the good electrolyte affinity of XNBR-Li and the interaction between-COO anions and Li⁺ ions in the cathode.

The morphologies of XNBR-Li and XNBR-based sulfur cathodes after the cycling test at 0.2 C for 100 cycles were examined by SEM. The XNBR-Li-based sulfur cathode still showed uniform dispersion of sulfur/carbon composite particles, while large cavities and some cracks formed in the XNBR-based cathode, which may be caused by the loss and drastic volume changes of sulfur during the cycling process. The results indicate that the use of XNBR-Li as the binder can effectively suppress the “shuttle effect” and withstand volume changes to maintain the integrity of the sulfur cathode.

In summary, lithiated XNBR (XNBR-Li) was synthesized by simply mixing LiOH with a commercial XNBR in NMP solution under mild conditions and used it as a binder to fabricate sulfur cathodes for LSBs for the first time. The sulfur cathode with XNBR-Li as the binder showed a notably improved performance with a capacity of 1140 mAh/g at the rate of 0.2 C, which is 12% and 15% higher than that of the sulfur cathodes using XNBR and PVDF as the binder, respectively. The XNBR-Li based sulfur cathode also showed higher rate capability with a high capacity of 729 mAh/g at 2 C compared to the capacity of 491 mAh/g for the XNBR-based sulfur cathode at the same rate. Furthermore, the XNBR-Li-based sulfur cathode achieved much higher cycling stability with a low-capacity decay of 0.04% per cycle at the rate of 0.5 C over 500 cycles. SEM images revealed that XNBR-Li has much better adhesion to the sulfur and carbon black particles, which improved the structural integrity of the cathode during battery cycling. Quantitative LPS trapping experiments using UV-vis spectroscopy and DFT computer simulations proved that the —COOLi group in XNBR-Li has a stronger LPS trapping ability than the —COOH group in XNBR. This helps to inhibit the shuttle effect of LPS and contribute to the excellent long-term cycle stability of the XNBR-Li-based sulfur cathode. The CV and EIS studies showed that the presence of —COOLi groups in XNBR-Li also significantly accelerated the diffusion kinetics of Li⁺ in the sulfur cathode, thus increasing the capacity and improving the rate capability of the battery. This work demonstrates that the simple lithiation of a commercial XNBR produced a novel high-performance functional XNBR-Li binder for high performance LSBs and possibly other types of rechargeable batteries such as sodium sulfur batteries and lithium-ion batteries.

At 0.2 C, the XNBR-Li-based sulfur cathode delivered a capacity of 1140 mAh/g, which is 12% and 15% higher than the one made with XNBR or PVDF as the binder, respectively. It also showed excellent rate capability with a capacity of 733 mAh/g even at a high rate of 2 C and only a capacity decay of 0.04% per cycle at the rate of 0.5 C over 500 cycles in the long-term cycling test. Due to the presence of the —COOLi groups, the charge transfer and Li⁺ diffusion of the XNBR-Li-based sulfur cathode were significantly improved, which explains the increase in specific capacity and the improvement of throughput performance. Interestingly, the LPS adsorption experiment showed that XNBR-Li has a much higher LPS trapping ability than XNBR. Density functional theory (DFT) calculations indicated that the binding energy (2.53 eV) between Li₂S₆ and the —COOLi group in XNBR-Li is much stronger than that (0.87 eV) between Li₂S₆ and the —COOH group in XNBR. Without wishing to be bound by theory, it is believed this may be responsible for the increased LPS trapping ability of XNBR-Li and thus the improved stability of the Li—S battery using this binder.

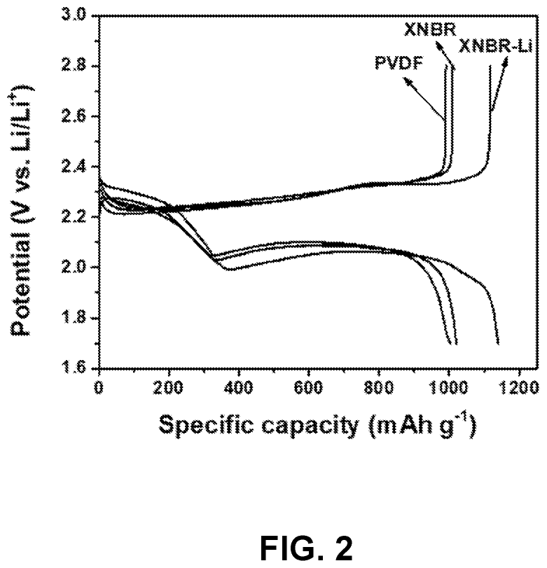

FIG. 2 is a graph showing the galvanostatic potential profiles of Li—S cells with 1.0 M LiTFSI DOL/DME (5/5) with 2 wt % LiNO₃ electrolyte at a 0.2 C rate.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A lithiated carboxylated nitrile butadiene rubber of the formula: 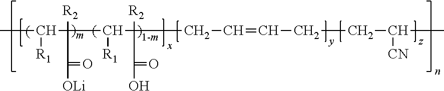
wherein R₁ is selected from the group consisting of hydrogen (H), a hydrocarbon group, and a carboxylic acid group (—COOH); R₂ is selected from the group consisting of hydrogen and a hydrocarbon group; x is in the range of about 0.05 to about 0.5; y is in the range of about 0.05 to about 0.75; z is in the range of about 0.05 to about 0.75; x+y+z=1; m is in the range of 0.1 to 1; and n is the number of repeat units and is in the range of from about 100 to about 1,000,000.

2. The lithiated carboxylated nitrile butadiene rubber of claim 1, having the formula:

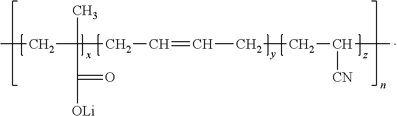

3. A sulfur cathode comprising:
a sulfur-containing material;
a conductive material; and
a lithiated carboxylated nitrile butadiene rubber binder.

4. The sulfur cathode of claim 3, wherein the lithiated carboxylated nitrile butadiene rubber binder is of the formula: 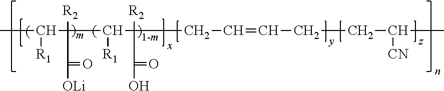
wherein R₁ is selected from the group consisting of hydrogen, a hydrocarbon group, a carboxylic acid group; R₂ is selected from the group consisting of hydrogen and a hydrocarbon group; x is in the range of about 0.05 to about 0.5; y is in the range of about 0.05 to about 0.75; z is in the range of about 0.05 to about 0.75; x+y+z=1; m is 0.1 to about 1; and n is the number of repeat units and is in the range of from about 100 to about 1,000,000.

5. The sulfur cathode of claim 3, wherein the lithiated carboxylated nitrile butadiene rubber binder is of the formula:

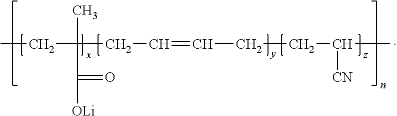

6. The sulfur cathode of claim 3, wherein the binder is included in an amount of from about 1 wt % to about 50 wt %.

7. The sulfur cathode of claim 3, wherein the binder is included in an amount of from about 2 wt % to about 30 wt %.

8. The sulfur cathode of claim 3, wherein the binder is included in an amount of from about 5 wt % to about 20 wt %.

9. The sulfur cathode of claim 3, wherein the sulfur-containing material comprises elemental sulfur; and/or wherein the conductive material comprises carbon black, carbon nanotubes, carbon nanofibers, graphene, or graphite.

10. (canceled)

11. A battery comprising:
a lithium anode and the sulfur cathode of claim 3.

12. The battery of claim 11, wherein the lithiated carboxylated nitrile butadiene rubber binder is of the formula 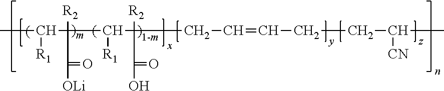
wherein R₁ is selected from the group consisting of hydrogen, a hydrocarbon group, and a carboxylic acid group; R₂ is selected from the group consisting of hydrogen and a hydrocarbon group; x is in the range of about 0.05 to about 0.5; y is in the range of about 0.05 to about 0.75; z is in the range of about 0.05 to about 0.75; x+y+z=1; m is 0.1 to 1; and n is the number of repeat units and is in the range of from about 100 to about 1,000,000.

13. The battery of claim 11, wherein the lithiated carboxylated nitrile butadiene rubber binder is of the formula:

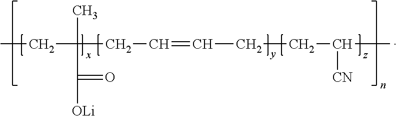

14. The battery of claim 11, wherein the binder is included in an amount of from about 5 wt % to about 30 wt %.

15. A method for synthesizing a lithiated carboxylated nitrile butadiene rubber comprising:
reacting a carboxylated nitrile butadiene rubber with lithium hydroxide.

16. The method of claim 15, wherein the carboxylated nitrile butadiene rubber has a carboxylic acid group content of from about 5 wt % to about 50 wt % and an acrylonitrile group content of from about 5 wt % to about 75 wt %.

17. The method of claim 15, wherein the carboxylated nitrile butadiene rubber has a carboxylic acid group content of about 7 wt % and an acrylonitrile group content of about 27 wt %.

18. The method of claim 15, wherein the lithium hydroxide is present at a molar ratio of from 0.1 to 1 to the amount of carboxylic acid groups of the carboxylated nitrile butadiene rubber.

19. The method of claim 15, wherein the lithium hydroxide is present at a molar ratio of 1:1 to the amount of carboxylic acid groups of the carboxylated nitrile butadiene rubber.

20. The method of claim 15, wherein the reaction occurs in a solvent selected from the group consisting of N-methyl-2-pyrrolidinone, N,N-dimethylformamide, N,N-dimethylacetamide, tetrahydrofuran, butyl acetate, ethyl butyl acetate, ethyl hexyl acetate, methyl glycol acetate, methyl ethyl ketone (MEK), methyl isobutyl ketone (MIBK), toluene, chlorobenzene, o-dichlorobenzene, and trichlorobenzene.

21. The method of claim 15, wherein the reaction occurs in N-methyl-2-pyrrolidinone; and/or wherein the reaction occurs at a temperature of from about 0° C. to about 100° C. for a period of from about 0.1 hour to about 24 hours; and/or wherein the reaction occurs at a temperature of about 70° C. for a period of about 2 hours.

22. (canceled)

23. (canceled)
